(19) United States
(12) Patent Application Publication
(10) Pub. No.: US 2016/0239768 A1
(43) Pub. Date: Aug. 18, 2016

(54) HUMAN CAPITAL BROWSER INCLUDING INTERACTIVE DATA VISUALIZATION TOOLS

(71) Applicant: Data Laboratories Limited, Spencers Wood (GB)

(72) Inventor: Samuel JONES, Cobham (GB)

(21) Appl. No.: 15/043,162

(22) Filed: Feb. 12, 2016

Related U.S. Application Data
(60) Provisional application No. 62/116,176, filed on Feb. 13, 2015.

(51) Int. Cl. G06Q 10/06; G06F 3/0484

(52) U.S. Cl. CPC G06Q 10/0631; G06F 3/0484

(57) ABSTRACT

Described herein are human capital browser applications featuring interactive displays of human capital data.

### CROSS-REFERENCE TO RELATED APPLICATIONS

This application claims the benefit of U.S. Provisional Application No. 62/116,176 filed Feb. 13, 2015, the entire contents of which is hereby incorporated by reference.

### BACKGROUND OF THE INVENTION

For years, the human resources (HR) function has shouldered much of the responsibility for managing people, in a largely segregated operation, seen by many as a “back office” function. Core HR is often part of an enterprise resource planning (ERP) suite with a focus on process automation, rather than user experience.

### SUMMARY OF THE INVENTION

According to Gartner's Magic Quadrant report, fewer than 25% of survey respondents (CIO's) said they were satisfied with talent management software's reporting and analytics functions. Described herein are business intelligence and analytics applications that help human resources professionals discover and share the stories behind their company's human capital data. The business intelligence and analytics applications described herein unify data from any source and convert the data into visual insight, making analytics simpler and more efficient. The disclosed applications enable users to explore, isolate and, act on human capital information in minutes, making accurate talent decisions, controlling costs, and building stronger teams.

In one aspect, disclosed herein are computer-implemented systems comprising: a digital processing device comprising an operating system configured to perform executable instructions and a memory; a computer program including instructions executable by the digital processing device to create a human capital browser application comprising: a software module configured to receive human capital data input, the human capital data pertaining to individuals of an organization; a software module configured to process the human capital data to generate a plurality of nodes, wherein each node represents at least one of the individuals of the organization and all individuals of the organization are represented by a node; a software module configured to apply an algorithm to generate an interactive visualization of the data, the visualization a targeting display comprising: the nodes arranged around an outermost circle, the nodes optionally sectored around the outermost circle of a plurality of concentric circles by one or more human capital parameters, the nodes targeted by one or more human capital parameters, each human capital parameter having a weight, the nodes arranged toward the center of the concentric circles by the one or more human capital parameters and their respective weights, the human capital parameters and the weights configurable in real-time; a software module configured to apply an algorithm to generate an interactive visualization of the data, the visualization a clustering display comprising: the nodes clustered based on one or more human capital parameters, the human capital parameters configurable in real-time; a software module configured to apply an algorithm to generate an interactive visualization of the data, the visualization a hierarchical display comprising: the nodes arranged in a plurality of concentric circles indicating job level within the organization and connected by lines indicating direct job reporting roles, a node representing a leader of the organization positioned at the center of the concentric circles; and a software module configured present interface elements allowing a user to filter, size, color, or any combination thereof, the nodes in the displays based on one or more human capital parameters, the human capital parameters configurable in real-time. In some embodiments, the human capital browser application further comprises a software module configured to apply an algorithm to generate an interactive visualization of the data, the visualization a barchart display ranked by one or more human capital parameters, the display comprising interface elements for configuration of the ranking parameters in real-time. In some embodiments, the human capital browser application further comprises a software module configured to apply an algorithm to generate an interactive visualization of the data, the visualization a scatterplot display comprising interface elements for configuration of the X-axis value and the Y-axis value in real-time. In some embodiments, the human capital browser application further comprises a software module configured to apply an algorithm to generate an interactive visualization of the data, the visualization a geographical map display comprising the nodes arranged on a map by one or more human capital parameters, the display comprising interface elements for configuration of the parameters in real-time. In some embodiments, the human capital parameters comprise one or more of: HR ID, home location, business family, business unit, start date, gender, job title, leave date, flexibility, performance rating, fixed compensation, bonus compensation, leave reason, parental return, promotion date, nationality, ethnicity, university attended, date of birth, disability, assignment location, hire type, and span of control. In other embodiments, the human capital parameters comprise: HR ID, home location, business family, business unit, start date, gender, job title, leave date, flexibility, performance rating, fixed compensation, bonus compensation, leave reason, parental return, promotion date, nationality, ethnicity, university attended, date of birth, disability, assignment location, hire type, and span of control. In yet other embodiments, the human capital parameters consist of: HR ID, home location, business family, business unit, start date, gender, job title, leave date, flexibility, performance rating, fixed compensation, bonus compensation, leave reason, parental return, promotion date, nationality, ethnicity, university attended, date of birth, disability, assignment location, hire type, and span of control. In some embodiments, the human capital data is input in spreadsheet format. In some embodiments, the human capital data is input in CSV or TSV format. In some embodiments, employee names are anonymized in the displays. In some embodiments, the software module configured to process the human capital data to generate a plurality of nodes is further configured to generate a callout for each node, the callout providing summary information pertaining to the individual, the callout activated by user interaction with the node. In further embodiments, the human capital browser application further comprises a software module configured to allow customization of the information provided by callouts, the module generating a preview to demonstrate the customized information. In some embodiments, the software module configured to process the human capital data to generate a plurality of nodes is further configured to generate a profile associated with each node, the profile providing detailed information pertaining to the individual. In further embodiments, the human capital browser application further comprises a software module configured to allow customization of the information provided by profiles, the module generating a preview to demonstrate the customized information. In some embodiments, the human capital browser application further comprises a software module configured to generate a report comprising a plurality of the displays.

In another aspect, disclosed herein are non-transitory computer-readable storage media encoded with a computer program including instructions executable by a processor to create a human capital browser application comprising: a software module configured to receive human capital data input, the human capital data pertaining to individuals of an organization; a software module configured to process the human capital data to generate a plurality of nodes, wherein each node represents at least one of the individuals of the organization and all individuals of the organization are represented by a node; a software module configured to apply an algorithm to generate an interactive visualization of the data, the visualization a targeting display comprising: the nodes arranged around an outermost circle, the nodes optionally sectored around the outermost circle of a plurality of concentric circles by one or more human capital parameters, the nodes targeted by one or more human capital parameters, each human capital parameter having a weight, the nodes arranged toward the center of the concentric circles by the one or more human capital parameters and their respective weights, the human capital parameters and the weights configurable in real-time; a software module configured to apply an algorithm to generate an interactive visualization of the data, the visualization a clustering display comprising: the nodes clustered based on one or more human capital parameters, the human capital parameters configurable in real-time; a software module configured to apply an algorithm to generate an interactive visualization of the data, the visualization a hierarchical display comprising: the nodes arranged in a plurality of concentric circles indicating job level within the organization and connected by lines indicating direct job reporting roles, a node representing a leader of the organization positioned at the center of the concentric circles; and a software module configured present interface elements allowing a user to filter, size, color, or any combination thereof, the nodes in the displays based on one or more human capital parameters, the human capital parameters configurable in real-time. In some embodiments, the human capital browser application further comprises a software module configured to apply an algorithm to generate an interactive visualization of the data, the visualization a barchart display ranked by one or more human capital parameters, the display comprising interface elements for configuration of the ranking parameters in real-time. In some embodiments, the human capital browser application further comprises a software module configured to apply an algorithm to generate an interactive visualization of the data, the visualization a scatterplot display comprising interface elements for configuration of the X-axis value and the Y-axis value in real-time. In some embodiments, the human capital browser application further comprises a software module configured to apply an algorithm to generate an interactive visualization of the data, the visualization a geographical map display comprising the nodes arranged on a map by one or more human capital parameters, the display comprising interface elements for configuration of the parameters in real-time. In some embodiments, the human capital parameters comprise one or more of: HR ID, home location, business family, business unit, start date, gender, job title, leave date, flexibility, performance rating, fixed compensation, bonus compensation, leave reason, parental return, promotion date, nationality, ethnicity, university attended, date of birth, disability, assignment location, hire type, and span of control. In other embodiments, the human capital parameters comprise: HR ID, home location, business family, business unit, start date, gender, job title, leave date, flexibility, performance rating, fixed compensation, bonus compensation, leave reason, parental return, promotion date, nationality, ethnicity, university attended, date of birth, disability, assignment location, hire type, and span of control. In yet other embodiments, the human capital parameters consist of: HR ID, home location, business family, business unit, start date, gender, job title, leave date, flexibility, performance rating, fixed compensation, bonus compensation, leave reason, parental return, promotion date, nationality, ethnicity, university attended, date of birth, disability, assignment location, hire type, and span of control. In some embodiments, the human capital data is input in spreadsheet format. In some embodiments, the human capital data is input in CSV or TSV format. In some embodiments, employee names are anonymized in the displays. In some embodiments, the software module configured to process the human capital data to generate a plurality of nodes is further configured to generate a callout for each node, the callout providing summary information pertaining to the individual, the callout activated by user interaction with the node. In further embodiments, the human capital browser application further comprises a software module configured to allow customization of the information provided by callouts, the module generating a preview to demonstrate the customized information. In some embodiments, the software module configured to process the human capital data to generate a plurality of nodes is further configured to generate a profile associated with each node, the profile providing detailed information pertaining to the individual. In further embodiments, the human capital browser application further comprises a software module configured to allow customization of the information provided by profiles, the module generating a preview to demonstrate the customized information. In some embodiments, the human capital browser application further comprises a software module configured to generate a report comprising a plurality of the displays.

In another aspect, disclosed herein are computer-implemented systems comprising: a digital processing device comprising an operating system configured to perform executable instructions and a memory; a computer program including instructions executable by the digital processing device to create a human capital browser application comprising: a software module configured to receive human capital data input, the human capital data pertaining to individuals of an organization; a software module configured to process the human capital data to generate a plurality of nodes, wherein each node represents at least one of the individuals of the organization and all individuals of the organization are represented by a node; a software module configured to apply an algorithm to generate an interactive visualization of the data, the visualization a targeting display comprising: the nodes arranged around an outermost circle, the nodes optionally sectored around the outermost circle of a plurality of concentric circles by one or more human capital parameters, the nodes targeted by one or more human capital parameters, each human capital parameter having a weight, the nodes arranged toward the center of the concentric circles by the one or more human capital parameters and their respective weights, the human capital parameters and the weights configurable in real-time; and a software module configured present interface elements allowing a user to filter, size, color, or any combination thereof, the nodes in the displays based on one or more human capital parameters, the human capital parameters configurable in real-time. In some embodiments, the human capital browser application further comprises a software module configured to apply an algorithm to generate an interactive visualization of the data, the visualization a clustering display comprising: the nodes clustered based on one or more human capital parameters, the human capital parameters configurable in real-time. In some embodiments, the human capital browser application further comprises a software module configured to apply an algorithm to generate an interactive visualization of the data, the visualization a hierarchical display comprising: the nodes arranged in a plurality of concentric circles indicating job level within the organization and connected by lines indicating direct job reporting roles, a node representing a leader of the organization positioned at the center of the concentric circles. In some embodiments, the human capital browser application further comprises a software module configured to apply an algorithm to generate an interactive visualization of the data, the visualization a barchart display ranked by one or more human capital parameters, the display comprising interface elements for configuration of the ranking parameters in real-time. In some embodiments, the human capital browser application further comprises a software module configured to apply an algorithm to generate an interactive visualization of the data, the visualization a scatterplot display comprising interface elements for configuration of the X-axis value and the Y-axis value in real-time. In some embodiments, the human capital browser application further comprises a software module configured to apply an algorithm to generate an interactive visualization of the data, the visualization a geographical map display comprising the nodes arranged on a map by one or more human capital parameters, the display comprising interface elements for configuration of the parameters in real-time. In some embodiments, the human capital parameters comprise one or more of: HR ID, home location, business family, business unit, start date, gender, job title, leave date, flexibility, performance rating, fixed compensation, bonus compensation, leave reason, parental return, promotion date, nationality, ethnicity, university attended, date of birth, disability, assignment location, hire type, and span of control. In other embodiments, the human capital parameters comprise: HR ID, home location, business family, business unit, start date, gender, job title, leave date, flexibility, performance rating, fixed compensation, bonus compensation, leave reason, parental return, promotion date, nationality, ethnicity, university attended, date of birth, disability, assignment location, hire type, and span of control. In yet other embodiments, the human capital parameters consist of: HR ID, home location, business family, business unit, start date, gender, job title, leave date, flexibility, performance rating, fixed compensation, bonus compensation, leave reason, parental return, promotion date, nationality, ethnicity, university attended, date of birth, disability, assignment location, hire type, and span of control. In some embodiments, the human capital data is input in spreadsheet format. In some embodiments, the human capital data is input in CSV or TSV format. In some embodiments, employee names are anonymized in the displays. In some embodiments, the software module configured to process the human capital data to generate a plurality of nodes is further configured to generate a callout for each node, the callout providing summary information pertaining to the individual, the callout activated by user interaction with the node. In further embodiments, the human capital browser application further comprises a software module configured to allow customization of the information provided by callouts, the module generating a preview to demonstrate the customized information. In some embodiments, the software module configured to process the human capital data to generate a plurality of nodes is further configured to generate a profile associated with each node, the profile providing detailed information pertaining to the individual. In further embodiments, the human capital browser application further comprises a software module configured to allow customization of the information provided by profiles, the module generating a preview to demonstrate the customized information. In some embodiments, the human capital browser application further comprises a software module configured to generate a report comprising a plurality of the displays.

In another aspect, disclosed herein are non-transitory computer-readable storage media encoded with a computer program including instructions executable by a processor to create a human capital browser application comprising: a software module configured to receive human capital data input, the human capital data pertaining to individuals of an organization; a software module configured to process the human capital data to generate a plurality of nodes, wherein each node represents at least one of the individuals of the organization and all individuals of the organization are represented by a node; a software module configured to apply an algorithm to generate an interactive visualization of the data, the visualization a targeting display comprising: the nodes arranged around an outermost circle, the nodes optionally sectored around the outermost circle of a plurality of concentric circles by one or more human capital parameters, the nodes targeted by one or more human capital parameters, each human capital parameter having a weight, the nodes arranged toward the center of the concentric circles by the one or more human capital parameters and their respective weights, the human capital parameters and the weights configurable in real-time; and a software module configured present interface elements allowing a user to filter, size, color, or any combination thereof, the nodes in the displays based on one or more human capital parameters, the human capital parameters configurable in real-time. In some embodiments, the human capital browser application further comprises a software module configured to apply an algorithm to generate an interactive visualization of the data, the visualization a clustering display comprising: the nodes clustered based on one or more human capital parameters, the human capital parameters configurable in real-time. In some embodiments, the human capital browser application further comprises a software module configured to apply an algorithm to generate an interactive visualization of the data, the visualization a hierarchical display comprising: the nodes arranged in a plurality of concentric circles indicating job level within the organization and connected by lines indicating direct job reporting roles, a node representing a leader of the organization positioned at the center of the concentric circles. In some embodiments, the human capital browser application further comprises a software module configured to apply an algorithm to generate an interactive visualization of the data, the visualization a barchart display ranked by one or more human capital parameters, the display comprising interface elements for configuration of the ranking parameters in real-time. In some embodiments, the human capital browser application further comprises a software module configured to apply an algorithm to generate an interactive visualization of the data, the visualization a scatterplot display comprising interface elements for configuration of the X-axis value and the Y-axis value in real-time. In some embodiments, the human capital browser application further comprises a software module configured to apply an algorithm to generate an interactive visualization of the data, the visualization a geographical map display comprising the nodes arranged on a map by one or more human capital parameters, the display comprising interface elements for configuration of the parameters in real-time. In some embodiments, the human capital parameters comprise one or more of: HR ID, home location, business family, business unit, start date, gender, job title, leave date, flexibility, performance rating, fixed compensation, bonus compensation, leave reason, parental return, promotion date, nationality, ethnicity, university attended, date of birth, disability, assignment location, hire type, and span of control. In other embodiments, the human capital parameters comprise: HR ID, home location, business family, business unit, start date, gender, job title, leave date, flexibility, performance rating, fixed compensation, bonus compensation, leave reason, parental return, promotion date, nationality, ethnicity, university attended, date of birth, disability, assignment location, hire type, and span of control. In yet other embodiments, the human capital parameters consist of: HR ID, home location, business family, business unit, start date, gender, job title, leave date, flexibility, performance rating, fixed compensation, bonus compensation, leave reason, parental return, promotion date, nationality, ethnicity, university attended, date of birth, disability, assignment location, hire type, and span of control. In some embodiments, the human capital data is input in spreadsheet format. In some embodiments, the human capital data is input in CSV or TSV format. In some embodiments, employee names are anonymized in the displays. In some embodiments, the software module configured to process the human capital data to generate a plurality of nodes is further configured to generate a callout for each node, the callout providing summary information pertaining to the individual, the callout activated by user interaction with the node. In further embodiments, the human capital browser application further comprises a software module configured to allow customization of the information provided by callouts, the module generating a preview to demonstrate the customized information. In some embodiments, the software module configured to process the human capital data to generate a plurality of nodes is further configured to generate a profile associated with each node, the profile providing detailed information pertaining to the individual. In further embodiments, the human capital browser application further comprises a software module configured to allow customization of the information provided by profiles, the module generating a preview to demonstrate the customized information. In some embodiments, the human capital browser application further comprises a software module configured to generate a report comprising a plurality of the displays.

### BRIEF DESCRIPTION OF THE DRAWINGS

FIG. 1 shows a non-limiting example of a human capital browser interface; in this case, an interface displaying human capital data in a table format.

FIG. 2a shows a non-limiting example of a human capital browser interface; in this case, an interface displaying human capital data in a first cluster format.

FIG. 2b shows a non-limiting example of a human capital browser interface; in this case, an interface displaying human capital data in a second cluster format.

FIG. 3a shows a non-limiting example of a human capital browser interface; in this case, an interface displaying human capital data in a first hierarchy format.

FIG. 3b shows a non-limiting example of a human capital browser interface; in this case, an interface displaying human capital data in a second hierarchy format.

FIG. 4 shows a non-limiting example of a human capital browser interface; in this case, an interface displaying human capital data in a bar chart format.

FIG. 5a shows a non-limiting example of a human capital browser interface; in this case, an interface displaying human capital data in a scatter plot format.

FIG. 5b shows a non-limiting example of a human capital browser interface; in this case, an interface for configuring parameters for a human capital data display in a scatter plot format.

FIG. 6a shows a non-limiting example of a human capital browser interface; in this case, an interface displaying human capital data in a targeting format.

FIG. 6b shows a non-limiting example of a human capital browser interface; in this case, an interface for configuring parameters for a human capital data display in a targeting format.

FIG. 7 shows a non-limiting example of a human capital browser interface; in this case, an interface displaying human capital data in a map format.

FIG. 8 shows a non-limiting example of a human capital browser interface; in this case, an interface displaying a human capital data report.

FIG. 9a shows a non-limiting example of a human capital browser interface; in this case, an interface for configuring parameters for profiles in a human capital data display.

FIG. 9b shows a non-limiting example of a human capital browser interface; in this case, an interface for configuring parameters for data point callouts in a human capital data display.

### DETAILED DESCRIPTION OF THE INVENTION

Described herein, in certain embodiments, are computer-implemented systems comprising: a digital processing device comprising an operating system configured to perform executable instructions and a memory; a computer program including instructions executable by the digital processing device to create a human capital browser application comprising: a software module configured to receive human capital data input, the human capital data pertaining to individuals of an organization; a software module configured to process the human capital data to generate a plurality of nodes, wherein each node represents at least one of the individuals of the organization and all individuals of the organization are represented by a node; a software module configured to apply an algorithm to generate an interactive visualization of the data, the visualization a targeting display comprising: the nodes arranged around an outermost circle, the nodes optionally sectored around the outermost circle of a plurality of concentric circles by one or more human capital parameters, the nodes targeted by one or more human capital parameters, each human capital parameter having a weight, the nodes arranged toward the center of the concentric circles by the one or more human capital parameters and their respective weights, the human capital parameters and the weights configurable in real-time; a software module configured to apply an algorithm to generate an interactive visualization of the data, the visualization a clustering display comprising: the nodes clustered based on one or more human capital parameters, the human capital parameters configurable in real-time; a software module configured to apply an algorithm to generate an interactive visualization of the data, the visualization a hierarchical display comprising: the nodes arranged in a plurality of concentric circles indicating job level within the organization and connected by lines indicating direct job reporting roles, a node representing a leader of the organization positioned at the center of the concentric circles; and a software module configured present interface elements allowing a user to filter, size, color, or any combination thereof, the nodes in the displays based on one or more human capital parameters, the human capital parameters configurable in real-time.

Also described herein, in certain embodiments, are non-transitory computer-readable storage media encoded with a computer program including instructions executable by a processor to create a human capital browser application comprising: a software module configured to receive human capital data input, the human capital data pertaining to individuals of an organization; a software module configured to process the human capital data to generate a plurality of nodes, wherein each node represents at least one of the individuals of the organization and all individuals of the organization are represented by a node; a software module configured to apply an algorithm to generate an interactive visualization of the data, the visualization a targeting display comprising: the nodes arranged around an outermost circle, the nodes optionally sectored around the outermost circle of a plurality of concentric circles by one or more human capital parameters, the nodes targeted by one or more human capital parameters, each human capital parameter having a weight, the nodes arranged toward the center of the concentric circles by the one or more human capital parameters and their respective weights, the human capital parameters and the weights configurable in real-time; a software module configured to apply an algorithm to generate an interactive visualization of the data, the visualization a clustering display comprising: the nodes clustered based on one or more human capital parameters, the human capital parameters configurable in real-time; a software module configured to apply an algorithm to generate an interactive visualization of the data, the visualization a hierarchical display comprising: the nodes arranged in a plurality of concentric circles indicating job level within the organization and connected by lines indicating direct job reporting roles, a node representing a leader of the organization positioned at the center of the concentric circles; and a software module configured present interface elements allowing a user to filter, size, color, or any combination thereof, the nodes in the displays based on one or more human capital parameters, the human capital parameters configurable in real-time.

Also described herein, in certain embodiments, are computer-implemented systems comprising: a digital processing device comprising an operating system configured to perform executable instructions and a memory; a computer program including instructions executable by the digital processing device to create a human capital browser application comprising: a software module configured to receive human capital data input, the human capital data pertaining to individuals of an organization; a software module configured to process the human capital data to generate a plurality of nodes, wherein each node represents at least one of the individuals of the organization and all individuals of the organization are represented by a node; a software module configured to apply an algorithm to generate an interactive visualization of the data, the visualization a targeting display comprising: the nodes arranged around an outermost circle, the nodes optionally sectored around the outermost circle of a plurality of concentric circles by one or more human capital parameters, the nodes targeted by one or more human capital parameters, each human capital parameter having a weight, the nodes arranged toward the center of the concentric circles by the one or more human capital parameters and their respective weights, the human capital parameters and the weights configurable in real-time; and a software module configured present interface elements allowing a user to filter, size, color, or any combination thereof, the nodes in the displays based on one or more human capital parameters, the human capital parameters configurable in real-time.

Also described herein, in certain embodiments, are non-transitory computer-readable storage media encoded with a computer program including instructions executable by a processor to create a human capital browser application comprising: a software module configured to receive human capital data input, the human capital data pertaining to individuals of an organization; a software module configured to process the human capital data to generate a plurality of nodes, wherein each node represents at least one of the individuals of the organization and all individuals of the organization are represented by a node; a software module configured to apply an algorithm to generate an interactive visualization of the data, the visualization a targeting display comprising: the nodes arranged around an outermost circle, the nodes optionally sectored around the outermost circle of a plurality of concentric circles by one or more human capital parameters, the nodes targeted by one or more human capital parameters, each human capital parameter having a weight, the nodes arranged toward the center of the concentric circles by the one or more human capital parameters and their respective weights, the human capital parameters and the weights configurable in real-time; and a software module configured present interface elements allowing a user to filter, size, color, or any combination thereof, the nodes in the displays based on one or more human capital parameters, the human capital parameters configurable in real-time.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Human Capital Data

In some embodiments, the systems, media, and applications described herein include human capital data, or use of the same. In further embodiments, the human capital data is suitably aggregate data. In other embodiments, the human capital data is suitably individual data. As used herein in some embodiments, “human capital” refers to the collection of competencies, knowledge, and attributes, including creativity, possessed by the individuals of an organization and embodied in the ability to perform labor so as to produce economic value. In further embodiments, the human capital data pertains to individuals. In still further embodiments, the human capital data pertains to individuals of an organization. The human capital data suitably pertains to individuals of a wide array of organizations. By way of non-limiting examples, the human capital data suitably pertains to individuals of a company, business entity, trade or professional organization, governmental agency, military force, non-profit organization, non-governmental organization, political organization, research organization, community, school or university, club, and the like.

Many types of human capital data are suitable. In some embodiments, suitable human capital data includes human resources identifiers (HR IDs). In further embodiments, HR IDs include numeric and alphanumeric identifiers used by human resource departments or software to refer to individuals. In some embodiments, suitable human capital data includes demographic information. In further embodiments, demographic information includes ethnicity, education, age, location, marital status, children, and the like. In some embodiments, suitable human capital data includes business information. In further embodiments, business information includes title, business division or unit, year hired, entry point to organization, year left (if any), maternity leave information, and the like. In further embodiments, business information includes compensation information such as promotion information, fixed compensation, bonus compensation, and the like. In further embodiments, business information includes performance information such as ratings, scores, reviews, evaluations, and the like.

In some embodiments, suitable human capital data includes data pertaining to bases of diversity, including, for example, gender, ethnicity, and nationality. In some embodiments, suitable human capital data includes, by way of non-limiting examples, country of hire, assignment country, employee level, business unit, specific team/function, performance ranking, promotion dates, highest education level achieved, university attended, start date, leave date and reason for leaving (e.g., redundancy, termination, resignation, etc.), maternity returner and date of return, flexible work contract (i.e., condensed hours, work from home, etc.), graduate or lateral hire, line manager status, high potential program attendees, mentoring/sponsorship program involvement, formal performance management, membership in an internal diversity network, and the like.

In some embodiments, the systems, media, and methods described herein include a software module configured to receive input of human capital data. In further embodiments, the data input is provided by manual data entry. In various embodiments, manual data entry is achieved, for example, by typing, pointing device, touchscreen, voice recognition, and the like. In other embodiments, the data input is provided by upload of an output from a human capital management application. In further embodiments, the data input is provided by upload of an output from human capital management applications by, for example, PeopleSoft, Workday, SAP, Infor, Accenture, and the like. In still further embodiments, the data input is provided in a format such as a database, a spreadsheet, comma-separated values (CSV), and tab-separated values (TSV), Extensible Markup Language (XML), and the like.

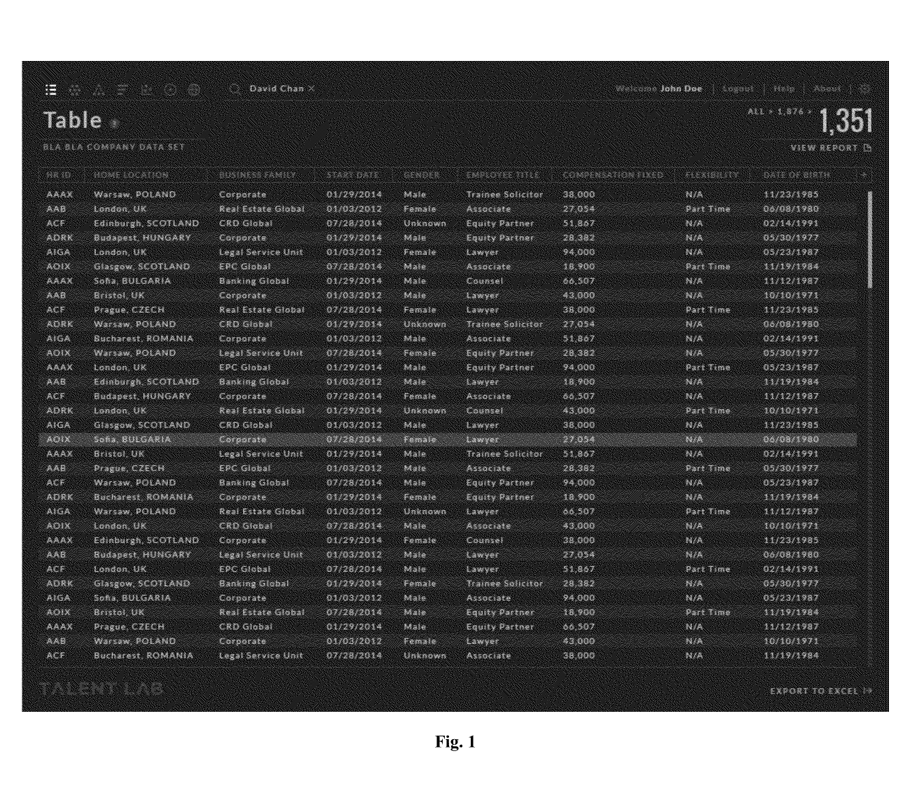

Referring to FIG. 1, in a particular embodiment, exemplary human capital data is displayed in a table format. In this embodiment, human capital data pertains to the individuals of a company and includes, HR ID, home location, business family, start date, gender, employee title, compensation fixed, flexibility, and date of birth.

### Nodes

In some embodiments, the systems, media, and applications described herein include human capital data nodes, or use of the same. In some embodiments, nodes are used to represent the individuals of an organization in human capital data visualization displays. In further embodiments, nodes are represented by distinct visual elements in a human capital data visualization display. Many types of visual elements are suitable, including, for example, geometric shape elements, such as dots or circles (filled or unfilled), squares, triangles, hexagons, and the like.

In some embodiments, a node represents a single individual of an organization. In other embodiments, a node represents a plurality of individual of an organization. In a particular embodiment, if the organization has a total number of individuals below a predetermined threshold, each node represents a single individual of the organization; whereas, if the organization has a total number of individuals above the predetermined threshold, each node represents a plurality of individuals of the organization.

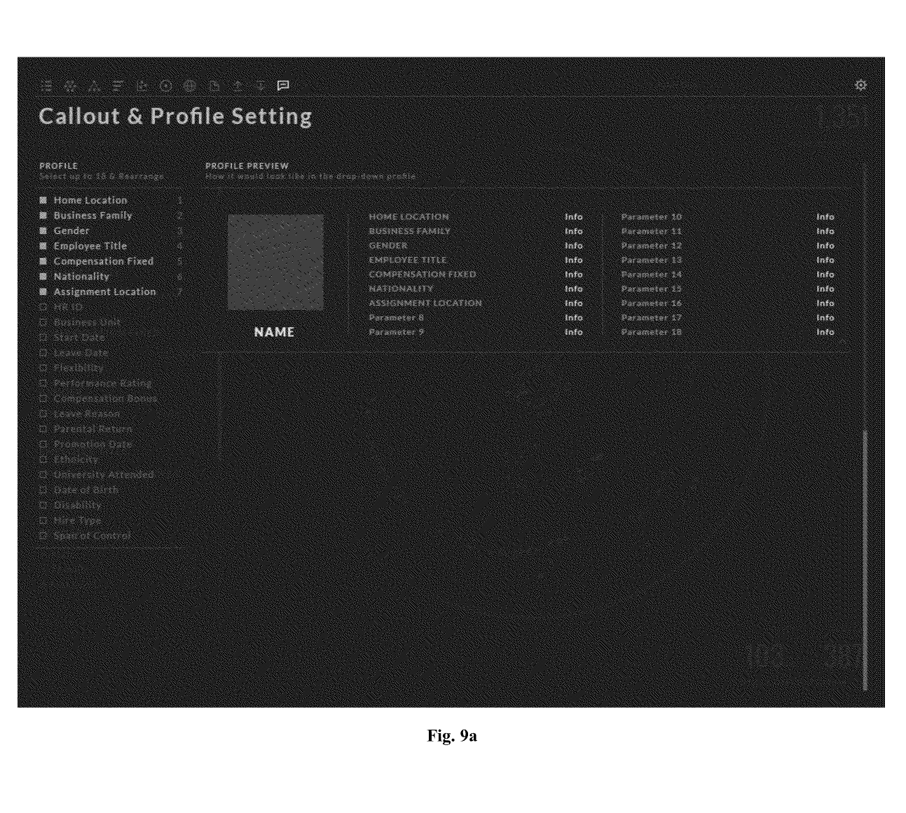

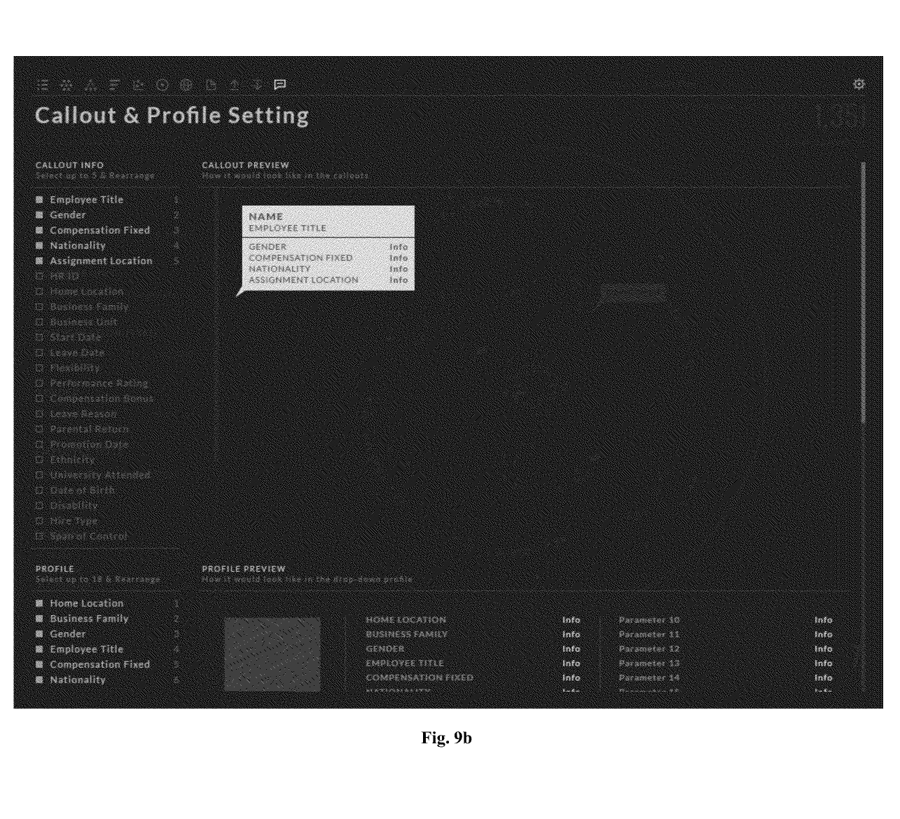

In some embodiments, the human capital data visualization displays described herein include a representation of each individual of an organization. In some embodiments, each individual is represented by a distinct node. In further embodiments, each node is associated with a user-configurable profile for an individual (see, e.g., FIG. 9a). In other embodiments, one or more individuals are represented in aggregate by one or more nodes.

In some embodiments, nodes are shaped, sized, colored, outlined, and/or highlighted, or the like, to indicate the presence, direction, and/or magnitude of one or more human capital parameters associated with the individuals represented by the node. In some embodiments, nodes are filtered (rendered visible or not visible) based on one or more human capital parameters.

### Human Capital Parameters

In some embodiments, the systems, media, and applications described herein include human capital parameters, or use of the same. In further embodiments, human capital parameters are informational elements associated with the individuals of an organization that are useful in evaluating human capital resources and/or making human capital decisions. In some embodiments, human capital parameters associated with nodes are visually indicated by shape, size, color, outline, highlight, or the like, including combinations thereof.

Many types of information are suitable. In various embodiments, suitable human capital parameters include, by way of non-limiting examples: HR ID, home location, business family, business unit, start date, gender, job title, leave date, flexibility, performance rating, fixed compensation, bonus compensation, leave reason, parental return, promotion date, nationality, ethnicity, university attended, date of birth, disability, assignment location, hire type, span of control, and combinations thereof.

In some embodiments, a human capital parameter has a value selected from a fixed group of possible values, e.g., male, female, decline to identify. In other embodiments, a human capital parameter has a value selected from a range of possible values, e.g., compensation. In yet other embodiments, a human capital parameter has an open ended value, e.g., job title.

### Clustering Display

In some embodiments, the systems, media, and applications described herein include a clustering display, or use of the same. In further embodiments, a clustering display clusters (e.g., groups or aggregates) the nodes based on one or more human capital parameters. In some embodiments, the, size, shape, color, etc. of the clustered nodes indicates the presence, direction, magnitude, etc., of the human capital parameters with regard to the nodes of the cluster. In a particular embodiment, an encompassing shape is generated around a cluster of nodes to define its boundaries. In some embodiments, a user optionally exports the clustering display (or any of the other displays) via PDF within the application.

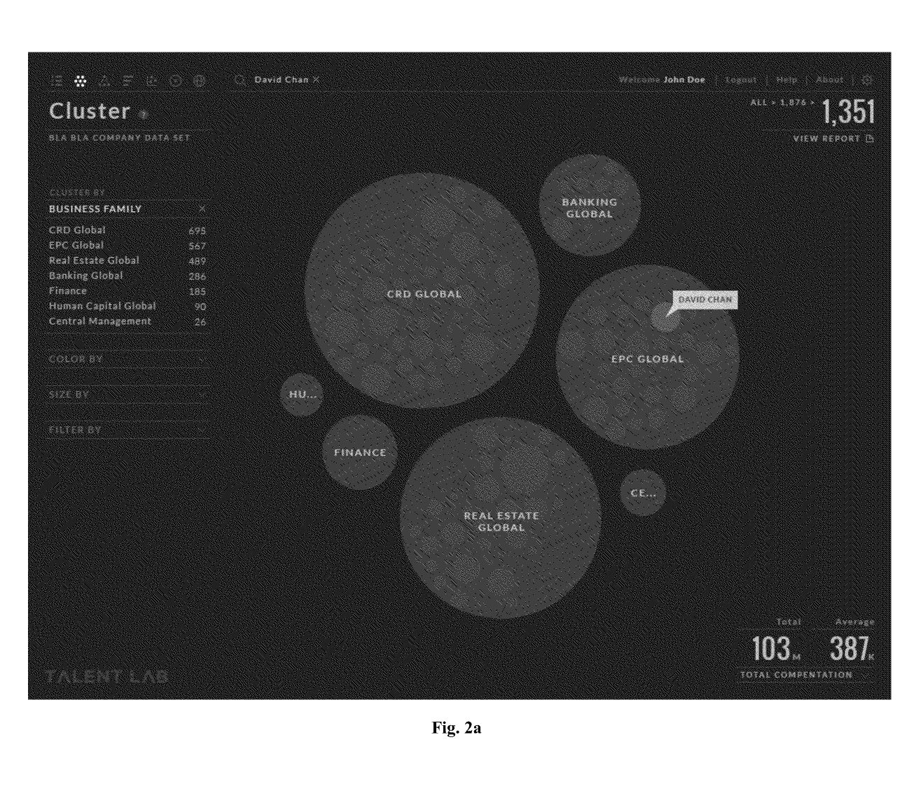

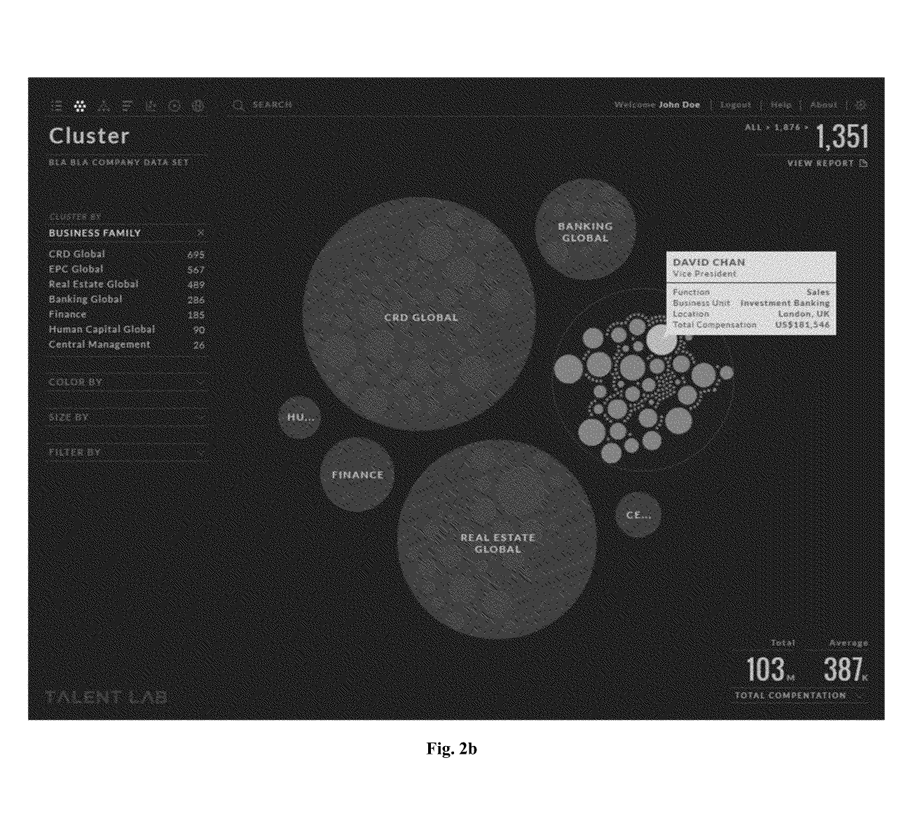

Referring to FIG. 2a, in a particular embodiment, nodes representing individuals of a company are clustered based on business family within the company (e.g., CRD Global, EPC Global, Real Estate Global, Banking Global, Finance, Human Capital Global, and Central Management). Each cluster of nodes is encompassed by a solid circle labeled with the name of the business family. In this embodiment, the nodes are optionally colored, sized, and/or filtered based on other human capital parameters to enhance the information presented by the display. Further in this embodiment, a callout for one particular node is active, indicating the name of the individual represented by the node (callouts are optionally configurable, see, e.g., FIG. 9b). In this embodiment, a user can transition between any of seven human capital visualization displays in real-time.

Referring to FIG. 2b, in a particular embodiment, nodes representing individuals of a company are clustered based on business family within the company (e.g., CRD Global, EPC Global, Real Estate Global, Banking Global, Finance, Human Capital Global, and Central Management). Each cluster of nodes is encompassed by an unfilled circle labeled with the name of the business family. In this embodiment, the nodes are optionally colored, sized, and/or filtered based on other human capital parameters to enhance the information presented by the display. Further in this embodiment, a callout for one particular node is active, indicating the name, title, function, business unit, location, and total compensation of the individual represented by the node. In this embodiment, a user can transition between any of seven human capital visualization displays in real-time.

### Hierarchical Display

In some embodiments, the systems, media, and applications described herein include a hierarchical display, or use of the same. In further embodiments, a hierarchical display arranges the nodes based on level or position within the organization. In still further embodiments, the node are arranged in a plurality of concentric circles and are connected by lines to indicate direct job reporting roles with the organization. In such embodiments, there is typically one leader arranged at the center, such as a top executive, e.g., CEO. In some embodiments, the, size, shape, color, etc. of the arranged nodes indicates the presence, direction, magnitude, etc., of one or more human capital parameters associated with the individual represented by the node. In some embodiments, a user optionally exports the hierarchical display (or any of the other displays) via PDF within the application.

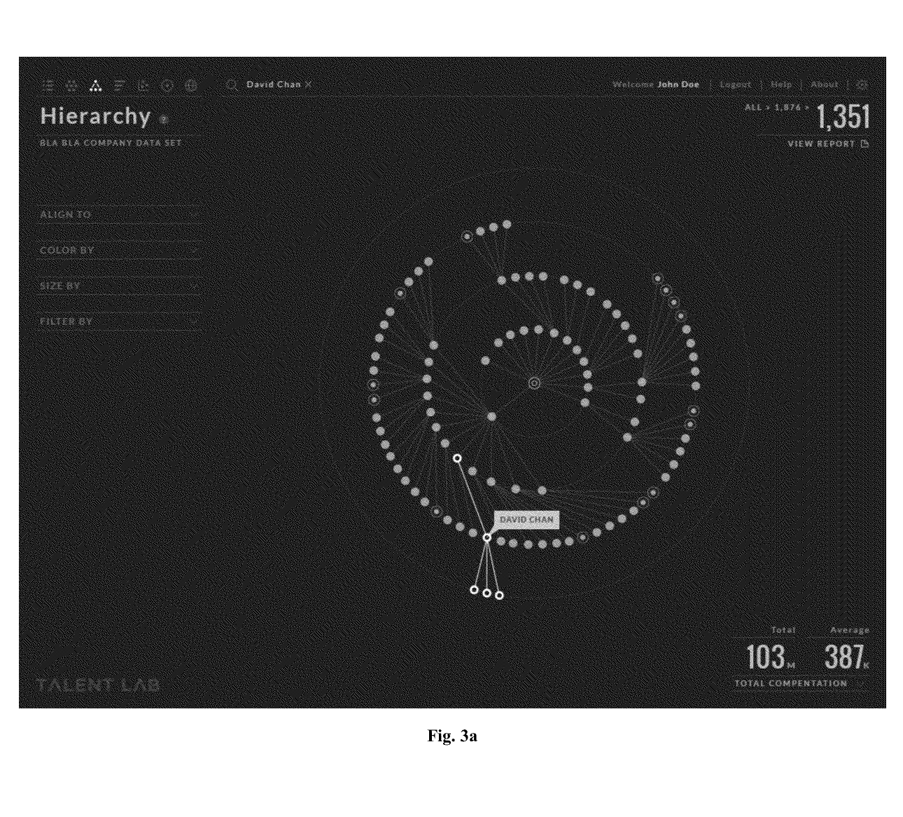

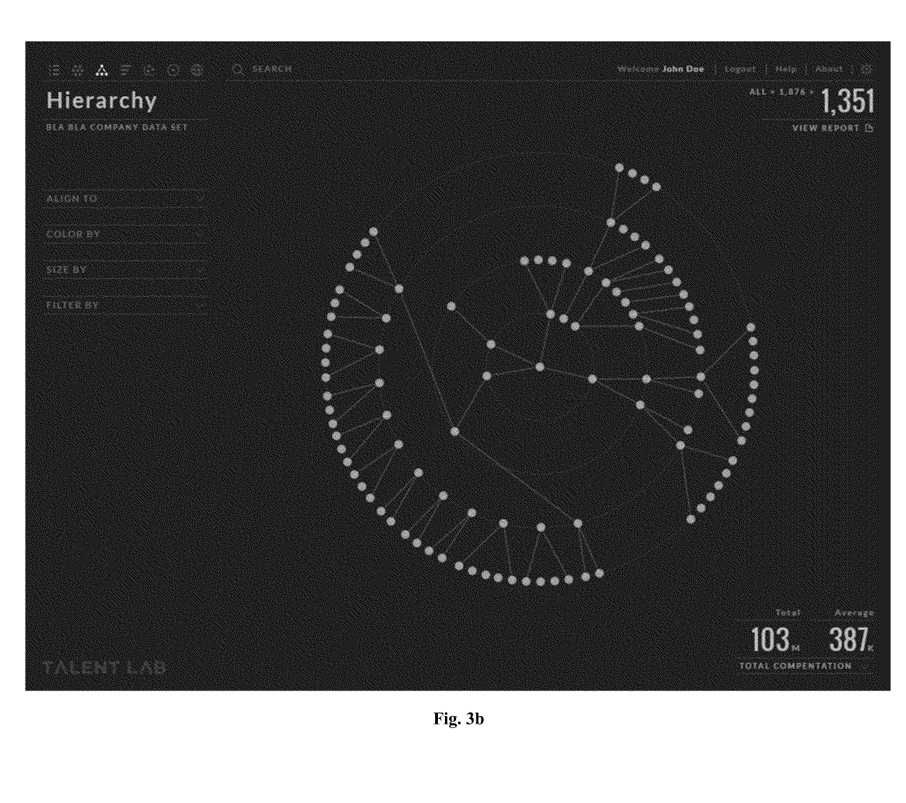

Referring to FIG. 3a, in a particular embodiment, a node representing a CEO of a company is arranged at the center of a hierarchical display. In this embodiment, the remainder of the nodes are arranged into four concentric circles around the central node indicating reporting structure. In this embodiment, the nodes are optionally colored, sized, and/or filtered based on other human capital parameters to enhance the information presented by the display. Further in this embodiment, a callout for one particular node is active, indicating the name of the individual represented by the node. For the node with the active callout, the lines of reporting, both up and down, are highlighted. In this embodiment, a user can transition between any of seven human capital visualization displays in real-time.

Referring to FIG. 3b, in a particular embodiment, a node representing a CEO of a company is arranged at the center of a hierarchical display. In this embodiment, the remainder of the nodes are arranged into four concentric circles around the central node indicating reporting structure. In this embodiment, the nodes are optionally colored, sized, and/or filtered based on other human capital parameters to enhance the information presented by the display. In this embodiment, it is apparent that the CEO has six direct reports. Further in this embodiment, a user can transition between any of seven human capital visualization displays in real-time.

### Scatterplot Display

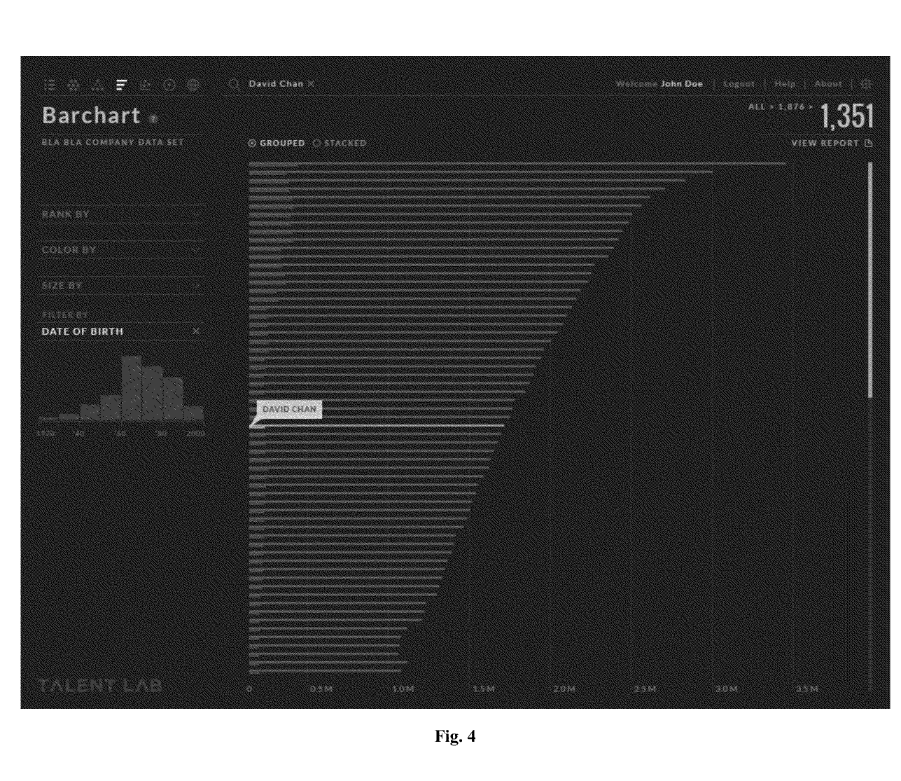

In some embodiments, the systems, media, and applications described herein include a scatterplot display, or use of the same. In further embodiments, a scatterplot display positions nodes along an X-axis and Y-Axis. In still further embodiments, the nodes are positioned based a user-configurable human capital parameter assigned to each axis. In some embodiments, the, size, shape, color, etc. of the positioned nodes indicates the presence, direction, magnitude, etc., of the human capital parameters with regard to the nodes of the cluster. In a particular embodiment, an encompassing shape is generated around a cluster of nodes to define its boundaries. In some embodiments, human capital data is also optionally visualized in barchart format (see, e.g., FIG. 4). In some embodiments, a user optionally exports the scatterplot display (or any of the other displays) via PDF within the application.

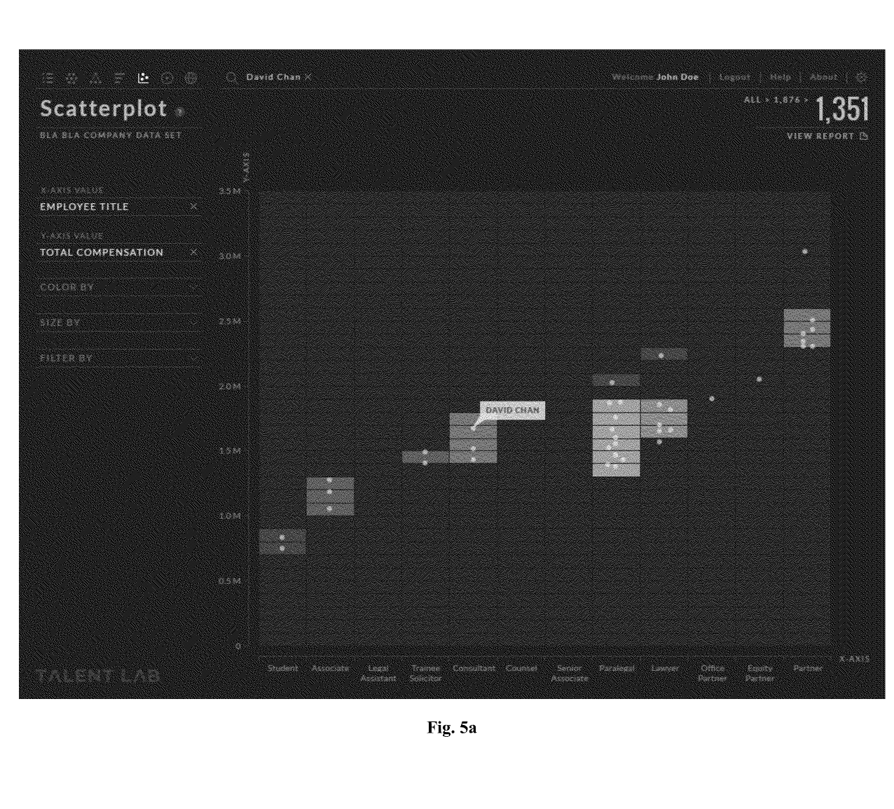

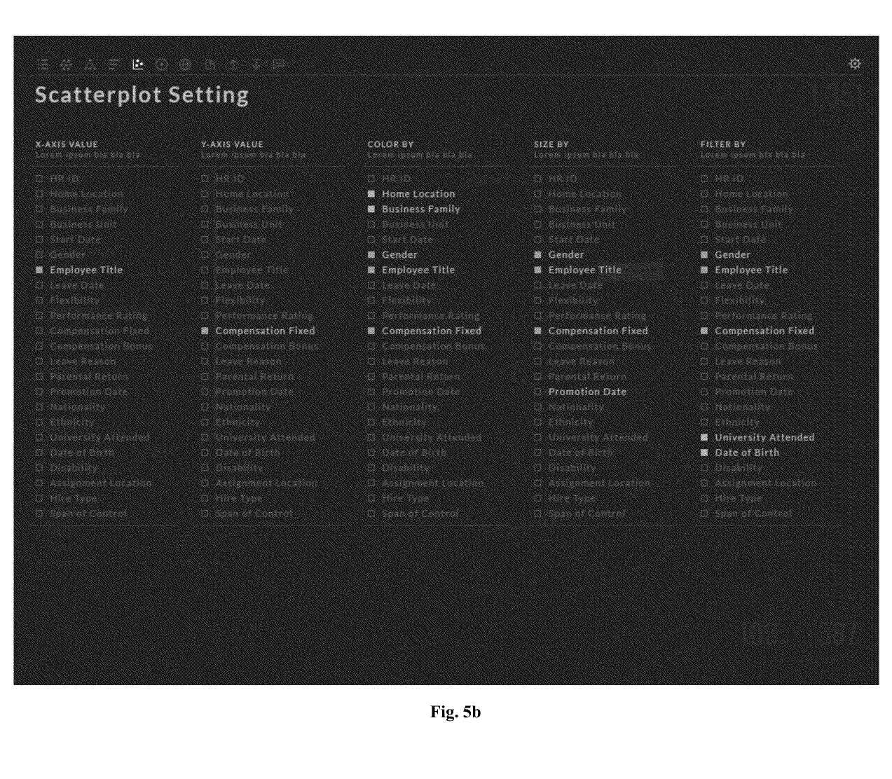

Referring to FIG. 5a, in a particular embodiment, nodes representing individuals of a company are positioned based on employee title on the X-axis and total compensation on the Y-Axis. A shaded box indicates regions of the display where many nodes fall. In this embodiment, the nodes are optionally colored, sized, and/or filtered based on other human capital parameters to enhance the information presented by the display. Further in this embodiment, a callout for one particular node is active, indicating the name of the individual represented by the node. In this embodiment, a user can transition between any of seven human capital visualization displays in real-time.

Referring to FIG. 5b, in a particular embodiment, a scatterplot settings interface allows a user to configure, in real-time, the human capital parameters associated with the X-axis and Y-axis of the display. In this embodiment, the interface also allows the user to configure human capital parameters used to color, size, and filter the nodes in the display.

Targeting display

In some embodiments, the systems, media, and applications described herein include a targeting display, or use of the same. In further embodiments, a targeting display arranges nodes around the perimeter of the outermost circle of a plurality of concentric circles. In still further embodiments, the nodes are sectored around the outermost circle based on one or more user-configurable human capital parameters. In some embodiments, the user is provided with interface elements allowing them to select one or more human capital parameters by which to target the nodes, wherein the user can assign a weight to each selected human capital parameter. Many schemas are suitable for assigning weighting, for example, a numeric score of 0-100. In further embodiments, the nodes are moved toward the center (e.g., targeted) based on their association with the selected parameters in accordance with the assigned weights. In some embodiments the display is interactive and the parameters and/or weights are user-configurable in real-time. In some embodiments, the, size, shape, color, etc. of the arranged nodes indicates the presence, direction, magnitude, etc., of the human capital parameters.

In a particular embodiment, the interactive targeting display comprises four concentric circles, each representing a quadrant. In further embodiments, at any stage, the user optionally selects all of the people in any of the four quadrants by isolating them—and optionally conducts more analysis anywhere in the application (e.g., using any of the other available features). For example, a user optionally isolates five candidates from the middle ring and utilizes a table view to see who they are and get further human capital information. In some embodiments, if a user hovers over one of the nodes they will see the profile of the individual. In some embodiments, a user optionally exports the targeting display (or any of the other displays) via PDF within the application.

In particular embodiments, the interactive targeting display is adapted for identifying suitable candidates for a job from a pool of candidates (e.g., recruiting). In other particular embodiments, the interactive targeting display is adapted for identifying suitable candidates for a promotion from a pool of employees. Human capital parameters particularly useful within the interactive targeting display include, by way of non-limiting examples: skills (related to jobs), knowledge, education, languages, location, age (or date of birth), gender, ethnicity, tenure with organization, performance level, compensation (e.g., base salary, bonus, or total), ethnicity, personality type (analytical/driver, amiable/expressive, etc.), work experience, prior company, university attended, potential rating, expat or not, trained in a particular qualification, high potential employee, high risk employee, future leader, parent, maternity leave, assigned/unassigned, employed, unemployed, and the like, including combinations thereof.

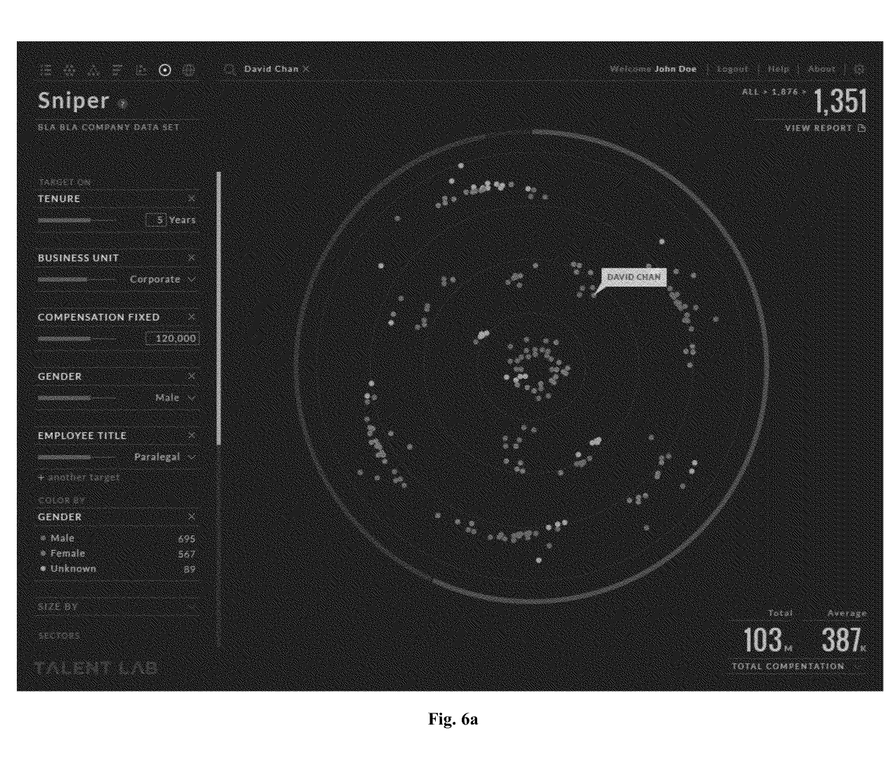

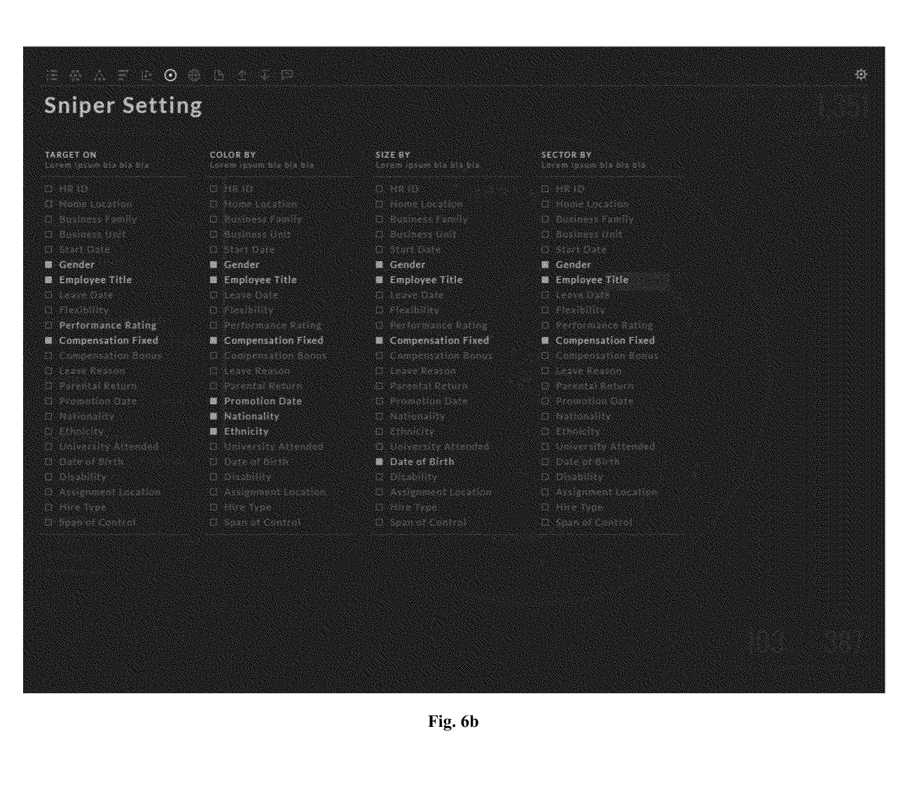

Referring to FIG. 6a, in a particular embodiment, nodes representing individuals of a company are positioned on a targeting display based on the human capital parameters tenure, business unit, compensation fixed, gender, and title, wherein each parameter is assigned a weight by the user. Based on the configured parameters and weights, a group of targeted nodes is identified within the innermost circle. In this embodiment, the nodes are colored based on gender to enhance the information presented by the display. Further in this embodiment, a callout for one particular node is active, indicating the name of the individual represented by the node. In this embodiment, a user can adjust the targeting parameter and/or weights and transition between any of seven human capital visualization displays in real-time.

Referring to FIG. 6b, in a particular embodiment, a targeting settings interface allows a user to configure, in real-time, the human capital parameters on which the nodes are targeted within the display. In this embodiment, the interface also allows the user to configure human capital parameters used to color, size, and sector the nodes in the display.

In some embodiments, the human capital browser application further comprises a software module configured to generate a human capital data report comprising a one or more of the displays. In various embodiments, a human capital data report comprises a clustering display, a scatterplot display, a hierarchical display, a targeting display, a map display, or a combination thereof.

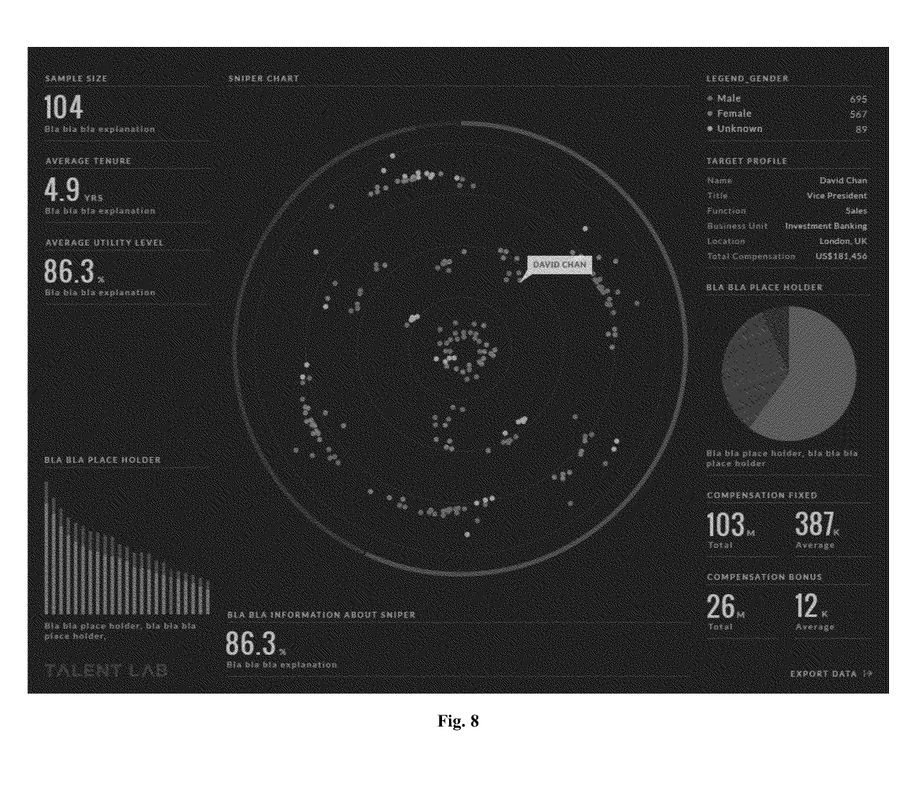

Referring to FIG. 8, in a particular embodiment, a human capital data report comprises human capital data in a targeting format (see, e.g., FIG. 6a). In this embodiment, the nodes of the display are color coded by gender and a target profile is identified. Further, in this embodiment, sample size, average tenure, average utility level, fixed compensation, and bonus compensation are provided in the report.

### Map Display

In some embodiments, the systems, media, and applications described herein include a map display, or use of the same. In further embodiments, a map display clusters (e.g., groups or aggregates) the nodes based on one or more human capital parameters in relevant geographical regions of the map. In some embodiments, the, size, shape, color, etc. of the clustered nodes indicates the presence, direction, magnitude, etc., of the human capital parameters with regard to the nodes of the cluster. In a particular embodiment, an encompassing shape is generated around a cluster of nodes to define its boundaries. In some embodiments, a user optionally exports the map display (or any of the other displays) via PDF within the application.

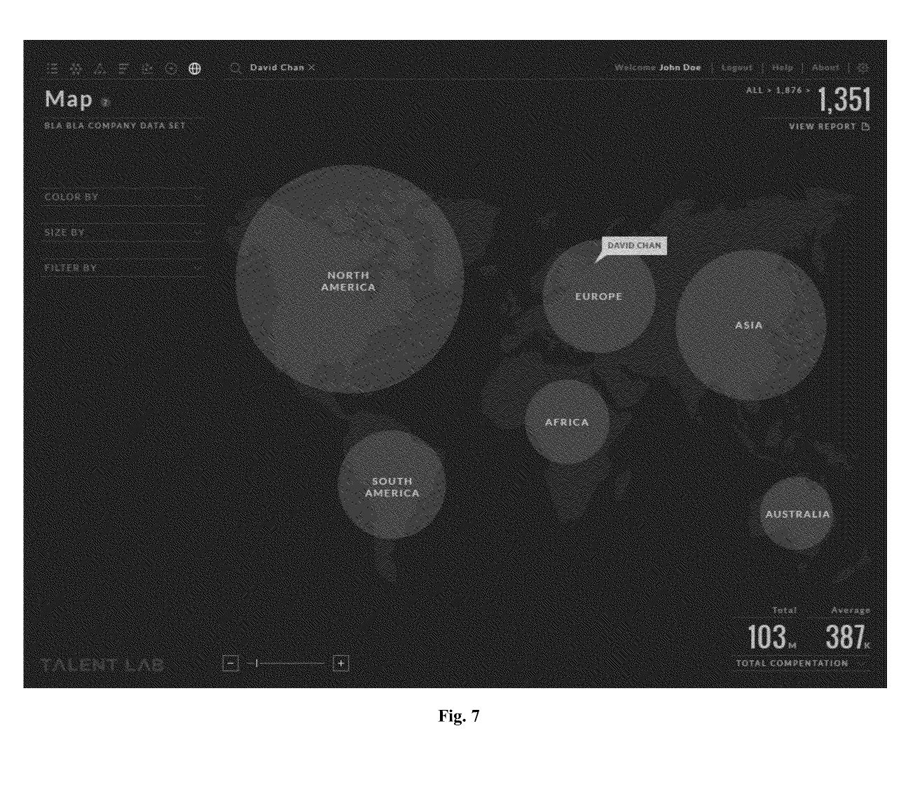

Referring to FIG. 7, in a particular embodiment, nodes representing individuals of a company are clustered based on home location within the company. Each cluster of nodes is encompassed by a solid circle labeled with the name of the location. In this embodiment, the nodes are optionally colored, sized, and/or filtered based on other human capital parameters to enhance the information presented by the display. Further in this embodiment, a callout for one particular node is active, indicating the name of the individual represented by the node. In this embodiment, a user can transition between any of seven human capital visualization displays in real-time.

### Digital Processing Device

In some embodiments, the systems, media, and applications described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync. Those of skill in the art will also recognize that suitable video game console operating systems include, by way of non-limiting examples, Sony® PS3, Sony® PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-transitory Computer Readable Storage Medium

In some embodiments, the systems, media, and applications disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the systems, media, and applications disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-in

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony PSP™ browser.

### Software Modules

In some embodiments, the systems, media, and applications disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the systems, media, and applications disclosed herein include one or more databases, or use of the same. In view of the disclosure provided herein, those of skill in the art will recognize that many databases are suitable for storage and retrieval of human capital information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1.-30. (canceled)

31. A computer-implemented system comprising:
a) a digital processing device comprising an operating system configured to perform executable instructions and a memory;
b) a computer program including instructions executable by the digital processing device to create a human capital browser application comprising:
i) a software module configured to receive human capital data input, the human capital data pertaining to individuals of an organization;
ii) a software module configured to process the human capital data to generate a plurality of nodes, wherein each node represents at least one of the individuals of the organization and all individuals of the organization are represented by a node;
iii) a software module configured to apply an algorithm to generate an interactive visualization of the data, the visualization a targeting display comprising: the nodes arranged around an outermost circle, the nodes optionally sectored around the outermost circle of a plurality of concentric circles by one or more human capital parameters, the nodes targeted by one or more human capital parameters, each human capital parameter having a weight, the nodes arranged toward the center of the concentric circles by the one or more human capital parameters and their respective weights, the human capital parameters and the weights configurable in real-time; and
iv) a software module configured present interface elements allowing a user to filter, size, color, or any combination thereof, the nodes in the displays based on one or more human capital parameters, the human capital parameters configurable in real-time.

32. The system of claim 31, wherein the human capital browser application further comprises a software module configured to apply an algorithm to generate an interactive visualization of the data, the visualization a clustering display comprising: the nodes clustered based on one or more human capital parameters, the human capital parameters configurable in real-time.

33. The system of claim 31, wherein the human capital browser application further comprises a software module configured to apply an algorithm to generate an interactive visualization of the data, the visualization a hierarchical display comprising: the nodes arranged in a plurality of concentric circles indicating job level within the organization and connected by lines indicating direct job reporting roles, a node representing a leader of the organization positioned at the center of the concentric circles.

34. The system of claim 31, wherein the human capital browser application further comprises a software module configured to apply an algorithm to generate an interactive visualization of the data, the visualization a barchart display ranked by one or more human capital parameters, the display comprising interface elements for configuration of the ranking parameters in real-time.

35. The system of claim 31, wherein the human capital browser application further comprises a software module configured to apply an algorithm to generate an interactive visualization of the data, the visualization a scatterplot display comprising interface elements for configuration of the X-axis value and the Y-axis value in real-time.

36. The system of claim 31, wherein the human capital browser application further comprises a software module configured to apply an algorithm to generate an interactive visualization of the data, the visualization a geographical map display comprising the nodes arranged on a map by one or more human capital parameters, the display comprising interface elements for configuration of the parameters in real-time.

37. The system of claim 31, wherein the human capital parameters comprise one or more of: HR ID, home location, business family, business unit, start date, gender, job title, leave date, flexibility, performance rating, fixed compensation, bonus compensation, leave reason, parental return, promotion date, nationality, ethnicity, university attended, date of birth, disability, assignment location, hire type, and span of control.

38. The system of claim 31, wherein the human capital parameters comprise: HR ID, home location, business family, business unit, start date, gender, job title, leave date, flexibility, performance rating, fixed compensation, bonus compensation, leave reason, parental return, promotion date, nationality, ethnicity, university attended, date of birth, disability, assignment location, hire type, and span of control.

39. The system of claim 31, wherein the human capital parameters consist of: HR ID, home location, business family, business unit, start date, gender, job title, leave date, flexibility, performance rating, fixed compensation, bonus compensation, leave reason, parental return, promotion date, nationality, ethnicity, university attended, date of birth, disability, assignment location, hire type, and span of control.

40. The system of claim 31, wherein the human capital data is input in spreadsheet format.

41. The system of claim 31, wherein the human capital data is input in CSV or TSV format.

42. The system of claim 31, wherein employee names are anonymized in the displays.

43. The system of claim 31, wherein the software module configured to process the human capital data to generate a plurality of nodes is further configured to generate a callout for each node, the callout providing summary information pertaining to the individual, the callout activated by user interaction with the node.

44. The system of claim 43, wherein the human capital browser application further comprises a software module configured to allow customization of the information provided by callouts, the module generating a preview to demonstrate the customized information.

45. The system of claim 31, wherein the software module configured to process the human capital data to generate a plurality of nodes is further configured to generate a profile associated with each node, the profile providing detailed information pertaining to the individual.

46. The system of claim 45, wherein the human capital browser application further comprises a software module configured to allow customization of the information provided by profiles, the module generating a preview to demonstrate the customized information.

47. The system of claim 31, wherein the human capital browser application further comprises a software module configured to generate a report comprising a plurality of the displays.

48. Non-transitory computer-readable storage media encoded with a computer program including instructions executable by a processor to create a human capital browser application comprising:
a) a software module configured to receive human capital data input, the human capital data pertaining to individuals of an organization;
b) a software module configured to process the human capital data to generate a plurality of nodes, wherein each node represents at least one of the individuals of the organization and all individuals of the organization are represented by a node;
c) a software module configured to apply an algorithm to generate an interactive visualization of the data, the visualization a targeting display comprising: the nodes arranged around an outermost circle, the nodes optionally sectored around the outermost circle of a plurality of concentric circles by one or more human capital parameters, the nodes targeted by one or more human capital parameters, each human capital parameter having a weight, the nodes arranged toward the center of the concentric circles by the one or more human capital parameters and their respective weights, the human capital parameters and the weights configurable in real-time; and
d) a software module configured present interface elements allowing a user to filter, size, color, or any combination thereof, the nodes in the displays based on one or more human capital parameters, the human capital parameters configurable in real-time.

49.-64. (canceled)
